(19) United States
(12) Patent Application Publication
(10) Pub. No.: US 2015/0207918 A1
(43) Pub. Date: Jul. 23, 2015

(54) MOBILE SYSTEM FOR TURNING A MOBILE PHONE SCREEN INTO A MIRROR

(71) Applicant: Troy Lockman, Newport News, VA (US)

(72) Inventor: Troy Lockman, Newport News, VA (US)

(21) Appl. No.: 14/159,393

(22) Filed: Jan. 20, 2014

(51) Int. Cl. H04M 1/725

(52) U.S. Cl. CPC H04M 1/72544; H04M 2201/42; H04M 2250/52

(57) ABSTRACT

A smartphone function that constructs a mirror function on a smartphone screen is disclosed. A front camera automatically turns on with a flip of touch and the image from the camera lens is viewed within a mirror frame that has a display window. This mirror image is styled with various styles. The current style of the mirror image can be replaced with another style of mirror image with a touch of one's finger.

### CROSS-REFERENCE

This Application claims the priority to the U.S. Provisional Application No. 61/849,053, filed on Jan. 18, 2013, and entirety of which is hereby incorporated by reference.

### DESCRIPTION OF RELATED ART

The present application relates to a method and system that enables a mobile phone to be used as mirror.

Note that the points discussed below may reflect the hindsight gained from the disclosed inventions, and are not necessarily admitted to be prior art.

With so many things to carry, most people don't carry a mirror with them while they are on the go. But it would be nice if there is a mirror handy. It would even be better if there are different mirrors all at once. It would be great if the mirrors change their style with a flip of finger tips.

So there is a need to provide such convenience with such a mirror.

### SUMMARY

The present application discloses a novel approach to generate an instant mirror, a method and process that turns a smartphone's camera and the screen into a mirror.

In one aspect of an embodiment, a touch of an image on a smartphone screen turns the camera of the smartphone to focus on the face of the phone holder.

In another aspect of an embodiment, the image provided by the phone camera is pointedly focused to an area of the face of the phone holder.

In another aspect of an embodiment, the image captured is pointedly presented within an area of a mirror image on the phone screen.

In another aspect of an embodiment, the mirror image is styled with various styles. The current style of the mirror image can be replaced with another style of mirror image with a touch of finger.

### BRIEF DESCRIPTION OF THE DRAWINGS

The disclosed application will be described with reference to the accompanying drawings, which show important sample embodiments of the invention and which are incorporated in the specification hereof by reference, wherein:

FIG. 1 schematically shows an example set of functional process in accordance with this application.

FIG. 2A shows an example smart phone that is stalled with a mirror function in accordance with this application.

FIG. 2B shows an example smart phone mirror on the screen of a smart phone screen in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

A smartphone software application that utilizes the phone's front facing camera to turn the phone into a mirror. The application automatically flips the camera so that it appears as if a user is looking into a real mirror. There are multiple styles of mirrors that a user can select from. The image that you see is the actual mirror image of yourself.

Additionally, this app allows the user to snap a photo and then zoom in for a closer look at the captured mirror image.

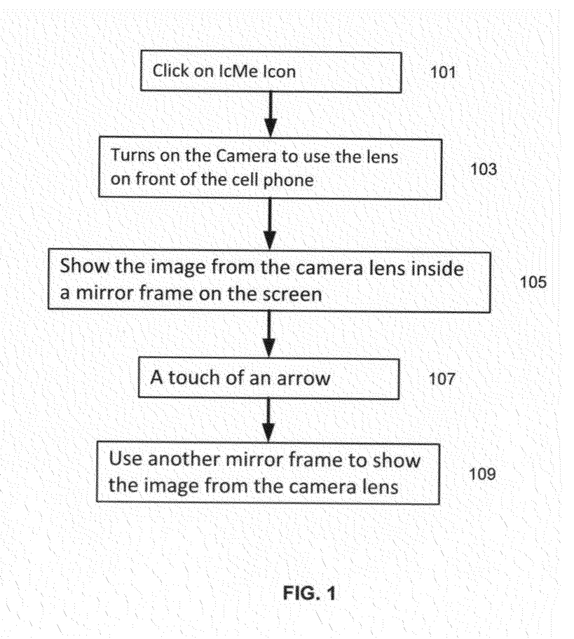

In reference to FIG. 1, an example functional process is shown. Clicking on the icon for the software on the screen of a smartphone at step 101 starts the software process. At step 103, the front camera is started and starts to show in the phone screen an image of the person who is holding the smartphone. However, the image is not randomly focused, the program automatically focuses the camera on the face of the person, and only display the image within a mirror frame at step 105. At step 107, the arrow function allows a user to change the mirror frame to another style. Several styles of the mirror frames are stored in the smartphone's hard drive and are available for selection. After selection at step 109, a different mirror frame is displayed on the smart phone screen.

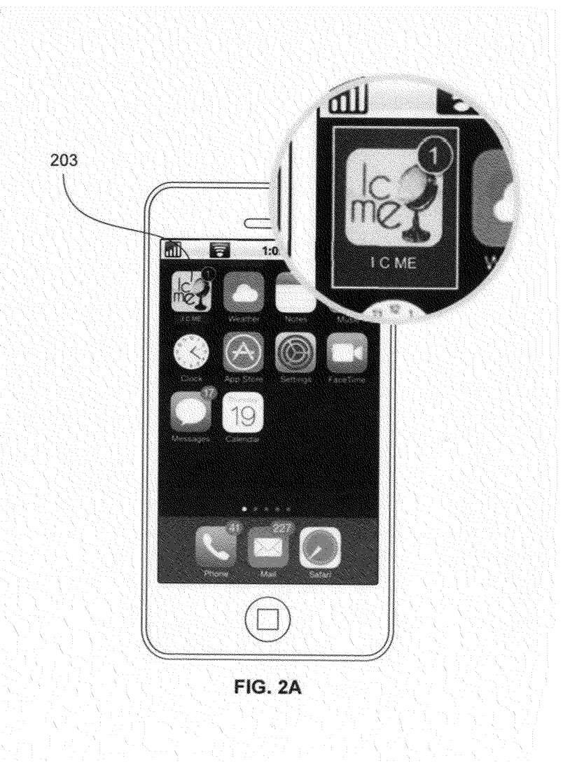

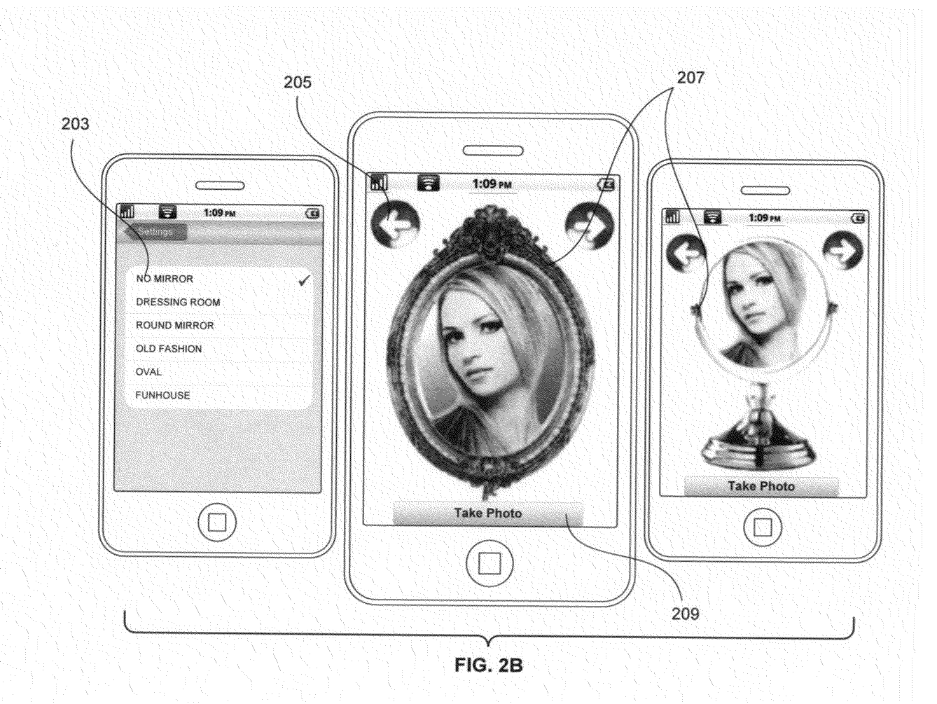

FIG. 2A and 2B show an example smartphone mirror. 201 is an icon to start the smartphone mirror. The mirror function includes a menu 203 for different styles of mirrors. 205 is an arrow function to change the present mirror style with the touch of a finger tip, 207 is the mirror frame that has a image displaying window to display the image that goes through the camera focus lens. Button 209 allows the camera to capture and store a digital image on the screen.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. A method for providing a mobile mirror on a smartphone screen having a front camera that takes photos a phone user, comprising the steps of the actions:
constructing a mirror frame graphic having a window for displaying images from a camera lens;
constructing a first button function that turns on the front camera with one touch of the smartphone screen, and said touch simultaneously displays said mirror frame graphic on the smartphone screen; and
installing said button function and said mirror frame graphic on the smartphone.

2. The method for providing a mobile mirror on a smartphone screen of claim 1, wherein said mirror frame graphic is selected from a plurality of mirror frame graphics that are stored on said smartphone.

3. The method for providing a mobile mirror on a smartphone screen of claim 1, further comprising the action of constructing a second button function that enables the smartphone to take a digital picture shown within said mirror frame graphic.

4. A mobile mirror on a smartphone screen having a front camera that takes photos a phone user, comprising:
a smartphone microchip processors that executes programming instructions for a set of software functional components, said software functional components including:
a mirror frame graphic having a window for displaying images from a camera lens; and
a first button function that turns on the front camera with one touch of the smartphone screen, and said touch simultaneously displays said mirror frame graphic on the smartphone screen.

5. The mobile mirror on a smartphone screen of claim 4, wherein said mirror frame graphic is selected from a plurality of mirror frame graphics that are stored on said smartphone.

6. The mobile mirror on a smartphone screen of claim 4, wherein said software functional components further include a second button function that enables the smartphone to take a digital picture shown within said mirror frame graphic.
